(19) United States
(12) Patent Application Publication
(10) Pub. No.: US 2015/0046345 A1
(43) Pub. Date: Feb. 12, 2015

(54) Method of creating value from intangible assets

(71) Applicants: Omar B. Hakim, Austin, TX (US); George Poletes, Dallas, TX (US)

(72) Inventors: Omar B. Hakim, Austin, TX (US); George Poletes, Dallas, TX (US)

(21) Appl. No.: 10/890,472

(22) Filed: Jul. 12, 2004

Related U.S. Application Data
(60) Provisional application No. 60/486,066, filed on Jul. 10, 2003.
(60) Provisional application No. 60/486,004, filed on Jul. 10, 2003.

(51) Int. Cl. G06Q 50/18; G06Q 10/00

(52) U.S. Cl. CPC G06Q 50/184; G06Q 10/00
USPC 705/310

(57) ABSTRACT

A computer-implemented method, includes storing information regarding a plurality of intangible assets, regarding a price to obtain an option to obtain a license or an option to purchase at least one intangible asset, and regarding a price to obtain a license for at least one intangible asset. The method also includes receiving a request for information for obtaining an option to obtain a license or to purchase at least one intangible asset. Also, the method includes processing the request and generating a message, where the message contains at least one term or condition for the option to obtain a license or purchase at least one intangible asset, and further where the message contains a price for obtaining the option to obtain a license or purchase at least one intangible asset. In addition, the method includes transmitting the message to the communication device.

### CROSS-REFERENCE TO RELATED APPLICATIONS

This application claims priority benefit to U.S. Provisional Application Ser. Nos. 60/486,004 filed on Jul. 10, 2003 and 60/486,066 filed on Jul. 10, 2003 by inventors Omar Hakim and George Poletes. This application is also related to U.S. Ser. No. 10/______, filed on Jul. 12, 2004 [Attorney Docket No. 41770-P002US] by the same inventors which is incorporated herein by reference.

### STATEMENT REGARDING FEDERALLY SPONSORED RESEARCH/DEVELOPMENT

Not Applicable.

### FIELD OF THE INVENTION

This invention generally relates to a method for creating value from intangible assets and in particular to a method for producing revenue from underutilized intellectual property, for example, patents, trademarks or copyrights.

### BACKGROUND OF THE INVENTION

Without limiting the scope of the invention, its background is described in connection with patents, trademarks, copyrights and other intellectual property and is best exemplified by methods for exploiting underutilized intellectual property.

The United States Patent and Trademark Office (USPTO) and foreign patent offices around the world issue thousands of patents each year. Corporations and educational institutions are among the organizations that file the largest number of applications to register intellectual property rights in their inventions. These inventions may be the culmination of substantial research and development efforts and funds. Naturally, these organizations are interested in recouping some, if not all of the expenditures for procuring patents. Ideally, corporations and educational institutions would realize profits on their patents or other intellectual properties.

Intellectual property may generally be categorized into three groups: intellectual property of known value to the owner, intellectual property of unknown value to the owner and intellectual property of no value to the owner. Intellectual property of known value includes intellectual property that the organization uses regularly or technology that is a primary focus of their business or research. The value of the intellectual property may not be quantifiable, but the owner considers this intellectual property to be core to their mission and therefore not to be sold or transferred to others. For example, processes for genetic seed engineering may be a core technology of an agricultural college. The agricultural college may obtain a patent on the method of genetically engineering the seed to protect this core technology. The college may actively use or license this patented technology daily and therefore, the seed patent is actively utilized to protect the core technology.

Intellectual property of unknown value may have been developed by accident or it may have been a technology that the company or university had explored but decided not to pursue. Intellectual property of unknown value may also be obtained to build assets for the organization. As an example, the agricultural college may have accidentally discovered a new and useful process for manufacturing textiles during their agricultural research. The agricultural college may obtain a patent to protect this process but eventually never exploit the patented technology. It is likely that intellectual property may simply be unused until the expiration of the intellectual property rights. Additionally, intellectual property of unknown value may be obtained for defensive purposes, e.g., to defend against an infringement law suit by providing potential infringement counterclaims. Intellectual property of no value is intellectual property that has no more commercial or other value to its owner. For example, a semiconductor company may patent a manufacturing process that is then abandoned by the company several years later in favor of a new and better manufacturing process. The abandoned patent may have many years of life before it expires, but it is no longer of value to the original patent holder.

In these instances, the intellectual property is not actively used but will still cost the organization over its lifetime. These costs, which include application preparation, filing fees, prosecution costs and maintenance fees, can amount to a significant sum for the organization. The organization may also incur significant costs to manage its intellectual property portfolio. Furthermore, if an organization procures and maintains corresponding foreign intellectual property, costs also increase significantly.

Therefore, what is needed is a method of managing intellectual property rights that does not allow rights to expire without having value during their lifetime.

### SUMMARY OF THE INVENTION

The present invention includes a method for creating value from intangible assets. The method has the steps of soliciting one or more options to an interest in one or more underutilized intangible assets from one or more owners of the underutilized intangible assets. The one or more options to an interest in the one or more underutilized intangible assets are then accepted into an option pool. One or more options are then exercised. One or more interests to the one or more underutilized intangible assets are then conveyed to another party, thereby creating value for the one or more underutilized intangible assets.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 is a schematic diagram of a value-creating system according to one embodiment of the present invention;

FIG. 2 is a flow diagram of a value-creating system according to one embodiment of the present invention;

FIG. 3 is a block diagram depicting a computer system according one embodiment of the present invention; and

FIG. 4 is a flow diagram of a valuation system according to one embodiment of the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

As discussed above, many organizations have expended significant resources to secure rights to various intellectual properties. Some of this intellectual property is actively used to generate revenue and protect business operations. Some intellectual property is unused or underutilized and simply consumes funds for management and maintenance fees without a corresponding return in value to the intellectual property owner.

Intellectual property is inherently difficult to valuate for many reasons. Real property, by contrast, may be valued by comparing a property to similar properties in a particular location and assigning a value to the property according to sales prices of the similar properties. Patents in a particular technology, by contrast, may be significantly unique and not have truly similar counterparts with which to compare. Additionally, even if comparable patents are identified, sales or valuation data for these patents may not be available. An owner of unused or underutilized intellectual property may have no notion of the value of a particular piece of intellectual property, aside from the cost of procuring the rights in the property. Furthermore, the owner may conclude that the time, costs, and resources associated with the valuation and negotiated transfer of such intellectual property far outweigh any anticipated monetary returns. Based on such considerations, the owner will fail to realize any returns or benefits on a significant, yet potentially valuable, portion of its intellectual property portfolio.

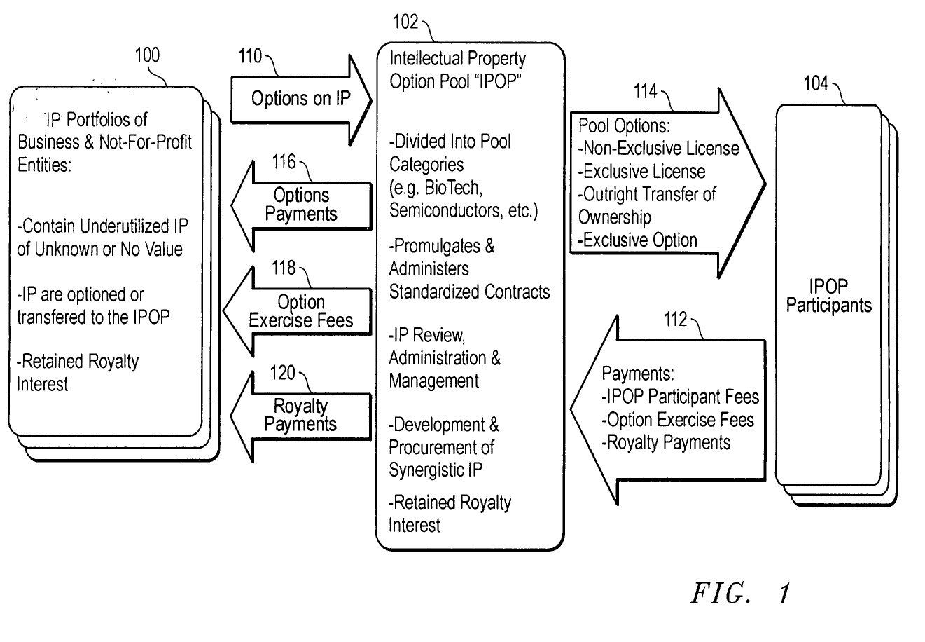

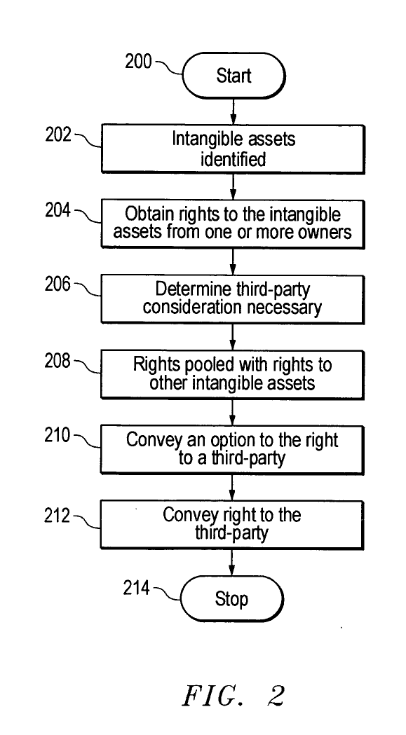

Referring now to FIGS. 1 and 2, a method and mechanism for owners to gain value from an intangible asset is shown. An intangible asset could be anything that is difficult to valuate. This detailed description, however, will generally describe the present invention with reference to intellectual property and, in particular to unused or underutilized patents. Value is created by first acquiring rights or options 110 for rights in intellectual property 100, such as underutilized patents, from an owner and placing these rights into a pool 102. The pool 102 of rights may then be marketed to other parties or organizations that are interested in gaining access into a particular field of technology or mining the pool for possibly valuable and overlooked rights. This pool 102 may also offer rights to fractional elements of the intellectual property. For example, specific patent claims may be assigned to the pool, or specific scenes from a copyright protected movie, or specific musical elements from a copyright protected song.

In one disclosed embodiment of the present invention, an Intellectual Property Option Pool (“IPOP”) has one or more options 110 that relate to various intellectual property rights 100 of an owner. The owner may grant to the pool 102 one or more options 110 to acquire rights in one or more intellectual property 100, which are owned by the owner. For example, the owner may convey options to a transfer of ownership, an exclusive license or a non-exclusive license with respect to each intellectual property.

The IPOP is one method for facilitating the efficient disposition and acquisition of underutilized intellectual property that is difficult to valuate. The IPOP is a comprehensive and standardized method of disposing and acquiring underutilized intellectual property. The method involves the use of a business entity that is comprised of participants (“Participants”) 104 who pay a periodic membership fee 112 in return for a contractual right 114 to obtain an interest in intellectual property from owners of underutilized intellectual property (“IP Owners”), with such “Interests” in the form of either: 1) an exclusive option of a pre-defined and limited duration; 2) an exclusive license; 3) a non-exclusive license; or 4) exclusive ownership of intellectual property. In one disclosed embodiment, the periodic membership fee 112 is waived or is not required to become a Participant 104.

Transactions may be conducted at fixed pricing and on contractual terms that are common to all Participants, thus facilitating the transfer of hard-to-value intellectual property by way of a quick, standardized, and efficient process. Parties seeking to acquire intellectual property may become Participants 104 of the IPOP by paying a fixed association fee 112 on a periodic and renewable basis. During its membership term in the IPOP, a Participant 104 has the right to acquire Interests in any available intellectual property that is subject to a “Pool Option” at fixed price points and on standardized terms and conditions common to all Participants 104.

Owners of intellectual property (“IP Owners”) may include the following: corporations, academic institutions, government entities, research foundations, financial institutions, investment firms, venture capitalists, bankruptcy estates, creditor-managed portfolios or individual inventors. IP Owners who are seeking to achieve monetary returns on certain of their unutilized intellectual property agree to enter into separate agreements with the IPOP to grant Options 110 to the Pool 102 which licenses Pool Options 114 to the Participants 104 with respect to each unutilized intellectual property selected by the IP Owners. All intellectual property that is subject to Pool Options may be listed in a searchable, network-accessible database, which may be indexed and categorized by the type of intellectual property and industry classification. For example, separate Pools may be created for mechanical technology, nanotechnology, biotechnology or carbon fiber technology.

A Pool Option 114 with respect to each optioned intellectual property may be of a fixed duration, after which time the option may either terminate or be renewed by the IP Owner. The terms of the Option 110 granted by an IP Owner may cover one or more intellectual property that the IP Owner chooses to include in the Pool 102. The Option 110 may be granted for intellectual property that has not been licensed to any outside party and is not subject to any restrictions on transfer or licensing.

The owner of the intellectual property, in granting the Option 110, may select one (or more, as permitted by the IPOP regulations) of the following interests (“Interests”) that may be acquired under the Pool Option 114 by each Participant 104 at a specified price and standardized terms and conditions:
a. Non-exclusive license. A Pool Option 114 with a non-exclusive license interest entitles each and every active Participant 104 to obtain a lifetime, non-exclusive license to the intellectual property.
b. Exclusive license. A Pool Option 114 with an exclusive license interest entitles the first participant 104 who tenders notice and payment according to the procedures of the IPOP to obtain a lifetime, exclusive license to the intellectual property.
c. Outright transfer of ownership. A Pool Option 114 with transfer of ownership interest entitles the first participant 104 who tenders notice and payment according to the procedures of the IPOP to acquire outright ownership of the intellectual property that is subject to this type of option.
d. Exclusive option. A Pool Option 114 with an exclusive option interest entitles the first participant 104 who tenders notice and payment according to the procedures of the IPOP to obtain either an exclusive license or a transfer of ownership, at a specified price and fixed terms and conditions, with respect to the intellectual property. The Exclusive Option is of limited duration, and if the Participant 104 does not exercise the Exclusive Option within the specified time frame, the intellectual property that is so subject to the Exclusive License is returned to the IPOP option pool 102 for the remainder of the underlying Pool Option's 114 term.

In granting a Pool Option 114 with respect to each intellectual property, the IP Owner may choose have the Pool Option 114 made available and grant to the Participant(s) 104 exercising the Pool Option 114 any of the above-listed interests (to the extent permitted by the IPOP regulations) and may change the type of available underlying Interest at any time during the term of the Pool Option 114.

A Participant 104 exercising a Pool Option 114 with respect to a selected intellectual property forwards to the IPOP or a designated escrow account, on behalf of the IP Owner, a contractually determined “Exercise Fee” 118 that corresponds to the type of Interest being acquired pursuant to the Pool Option 114 exercise. The prices, terms, and conditions of the above-listed Interests will vary according to the category of the Interest available with respect the intellectual property subject to the Pool Option (e.g. exclusive license vs. outright transfer of ownership) 114. In addition to an Exercise Fee 118 paid to the IP Owner, the Participant 104 grants the IP Owner and IPOP (at pre-defined sharing percentages) a retained “upside” interest (“Retained Interest”) 120 if an extraordinary financial return on the intellectual property is realized.

The Retained Interest 120 is a remainder royalty interest in the transferred intellectual property that may accrue to the IP Owner and the IPOP upon the attainment of certain pre-defined dollar amount returns on the transferred intellectual property, such as revenues generated or infringement damages (and licensing fees deriving therefrom), which is derived by the Participant with respect to the transferred intellectual property.

IP Owners may receive periodic option payments (“Option Payments”) 116 on each intellectual property that is actively subject to a Pool Option 114. Such a periodic payment with respect to a particular intellectual property will be prorated based on the duration of the Pool Option 114 to which the intellectual property is subject within a given Option Payment period. Alternatively, IP Owners may not receive the aforementioned Option Payments 116.

To acquire an Interest in any listed intellectual property, a Participant 104 may exercise its Pool Option 114 according to the following procedure:
i. the Participant 104 accesses and selects intellectual property in which it seeks to acquire an Interest by tendering notice of its intent to acquire the Interest; and
ii. the Participant 104 transfers to the IPOP (or an escrow account established by the IPOP) funds 112 to complete the option exercise and acquisition of the Interest and, pursuant to the Participant's 104 previous execution of the standardized legal instruments promulgated by the IPOP, the Interest is transferred by the IP Owner to the Participant 104.

The IPOP may generate revenue from sources such as association fees and a percentage of all Retained Interests. These revenues may be distributed to the IPOP operator or they may be reinvested into developing technology within the IPOP or procuring synergistic intellectual property that may result from a combination of intellectual property within the IPOP.

One attractive feature to Participants 104 in the IPOP is the promulgation of standard contracts. All IP Owners and Participants 104 may execute standard agreements, with fixed pricing and uniform terms and conditions. For example, a standard Option Contract between the IPOP and each IP Owner or a standard Participant Contract between the IPOP and each Participant may be developed to streamline the negotiation process typically associated with intellectual property transactions. Interest transfer agreements, which may be incorporated by reference into the “Option Contract” and the “Participant Contract,” can standardize, among other things, the pricing and terms and conditions of the transfer of each type of Interest. These standardized agreements eliminate time and expense required to negotiate separate agreements for each transaction and serve to streamline the entire transfer process and lower the associated costs.

The IPOP operator or manager may also provide other valuable service to the Participants 104. For example, a preliminary intellectual property review and ownership validation may protect a participant from attempted fraudulent transfers of intellectual property and help to ensure the Participant 104 is receiving a valid and unencumbered right.

The IPOP operator may also provide management services, such as managing Participant 104 and IP Owner accounts, which may include contract execution, distribution, and administration and support of Interest transfers, for example. These services may also include the management and administration of Retained Interests, including payment and enforcement of terms and conditions. Additionally, the IPOP operator may manage the portfolio of intellectual property subject to Pool Options.

Referring now to FIG. 2, a flow diagram is shown. The process begins with start 200. Next, in step 202, the intangible assets are identified. The intangible assets may relate to a specific industry or to a class of products or services. The intangible assets may also lie outside the line of business or field of use of an asset holder that owns the intangible asset or that has a right to convey a license to the intangible asset. The intangible assets include, but are not limited to trademarks, copyrights and patents.

In step 204, the right in the intangible asset is obtained from the asset holder. The asset owner may own the intangible asset or have the right to convey a license to the intangible asset. The asset holder may assign the right, provide an exclusive license to the right, or provide a non-exclusive license to the right. In one disclosed embodiment, a set of standardized or predetermined terms and conditions are used to reduce the necessity for negotiation and to reduce the overall costs. The right obtained may include the right either to convey a license to the intangible asset to a third-party or to facilitate, as an agent of the asset holder, conveyance of a license to the intangible asset to a third-party. The value of the right obtained may vary. The actual or perceived transaction cost of negotiating transfers of the rights in an asset-by-asset or face-to-face manner may exceed the actual or perceived benefit of consummating the transfers. Next, in step 206, the amount of consideration that a third-party must pay to obtain the right to the intangible asset is determined. The amount of consideration may vary dependent upon the specific right obtained, such as a license to or an assignment of the intangible asset. In one disclosed embodiment, multiple intangible assets are obtained from multiple asset holders.

In step 208, the obtained rights are pooled with rights in other intangible assets acquired from one or more other asset holders. Multiple pools may be formed, where intangible assets that relate to said industry or class of products or services are combined together. The intangible assets in a specific pool may relate to a variety of different products or services within a specific industry or class of products or services. The specific pools may be created based upon the industry or class of products or services defined by a Standard Industrial Classification (SIC) number or by a North American Industry Classification System (NAICS) number. Next, in step 210, the option to the right obtained is conveyed to a third-party. In one disclosed embodiment, the conveying, or facilitating conveyance, of an option for a particular right to a particular intangible asset in the pool to a third-party is accomplished under a second set of standardized or predetermined terms and conditions. The rights obtained may be optioned to multiple third-parties, each accomplished under the second set of standardized or predetermined terms and conditions. The consideration paid by the third-party for the option is also a standardized or predetermined function of the consideration that the third-party must pay to exercise the option.

In step 212 the right is conveyed via a license to or an assignment of the particular right optioned to the third-party. In this embodiment, the third-party's exercise of the option is accomplished under a third set of standardized or predetermined terms and conditions. Again, multiple third parties may obtain the rights from the pool. In one disclosed embodiment, the amount of consideration paid by a third-party to exercise the option for a particular right is inversely related to the extent to which the third-party exploits that particular right. The process ends with stop 214.

In one disclosed embodiment, the IPOP is a method of listing an intangible asset for sale or license through the use of option contracts and pre-defined sales or licensing terms. If an interested party wants to explore or examine a technology, they can purchase an option contract that gives them IP usage rights and technology access for the duration of the option contract period. At the expiration of the option contract period, the interested party can allow the option to lapse, purchase another option contract or enter into a licensing agreement with predetermined terms. The predetermined licensing terms allows the option holder to make a go/no-go business decision based upon the feasibility of the technology, and not based upon the potential outcome of future licensing negotiations. For the technology owner, the IPOP provides a simplified method of finding licensees for technologies without the burden and expense of licensing negotiations. When mature technologies in one industry are licensed outside their field-of-use, licensing negotiations can become cumbersome since the value metrics that can be applied to the technology may not necessarily apply in the new field-of-use. The IPOP is primarily used to license single technologies one at a time

In one disclosed embodiment, the IPOP identifies an asset that relates to a particular industry. Under a first set of predetermined terms, the IPOP obtains a right in the asset from an “asset holder” who possesses at least a right to convey a license to the asset. The obtained right includes at least the right to facilitate conveyance of a license to the asset to a third-party. The IPOP pools the obtained right together with other rights in assets acquired from one or more other asset holders, thereby forming a pool of rights in assets that relate to the particular industry. Under a second set of predetermined terms, the IPOP then conveys, or facilitates conveyance, to a third-party of a license to specific rights in the pool.

As used herein, the term “particular industry” refers to an industry, sub-industry or line of business that makes, sells or uses a particular class or subclass of products, processes or services. When an asset holder “possesses at least a right to convey a license to the asset,” the asset holder may own the asset outright or may merely possess the right to sublicense all or partial rights in the asset. A “set of predetermined terms” refers to a set of terms and conditions that is standardized and uniform in comparison to the terms and conditions applied to other assets in the pool. Preferably, the terms and conditions are predetermined in a uniform manner that applies to all or substantially all assets in the pool. More preferably, the consideration paid to the asset holder and/or the consideration payable by the third-party is predetermined in accordance with a formula that applies to all like assets in the pool. Most preferably, the consideration can be calculated by a computer or in an otherwise automated or rote manner.

Except where stated otherwise, the phrase “at least the right to facilitate conveyance of a license to the asset to a third-party” means that the minimum right obtained by the IPOP is the right to facilitate such conveyance as an official or de facto agent of the asset holder. The IPOP may have much greater rights. For example, if the IPOP obtained an assignment from the asset holder, the IPOP may own the asset outright. Alternatively, the IPOP may, for example, have obtained an exclusive license from the asset holder.

With regard to a plurality of the assets in the pool, the transaction cost of negotiating transfers of rights to each asset in an individualized manner may exceed the benefit of consummating the transfers in an individualized manner. This may also be true for substantially all of the assets in the pool. Except where stated otherwise, the term “transaction cost” refers to (1) the actual transaction cost for either or both the asset holder and the third-party or (2) the transaction cost perceived by either or both the asset holder and the third party. Likewise, except where stated otherwise, the term “benefit” refers to the actual benefit to, or the benefit perceived by, either or both the asset holder or the third-party. Negotiating the transfer of an asset right in an “individualized manner” refers to negotiating for the transfer in an asset-by-asset or face-to-face manner. In other words, such transfers entail bargaining, deliberation or back and forth communication between people who represent the parties.

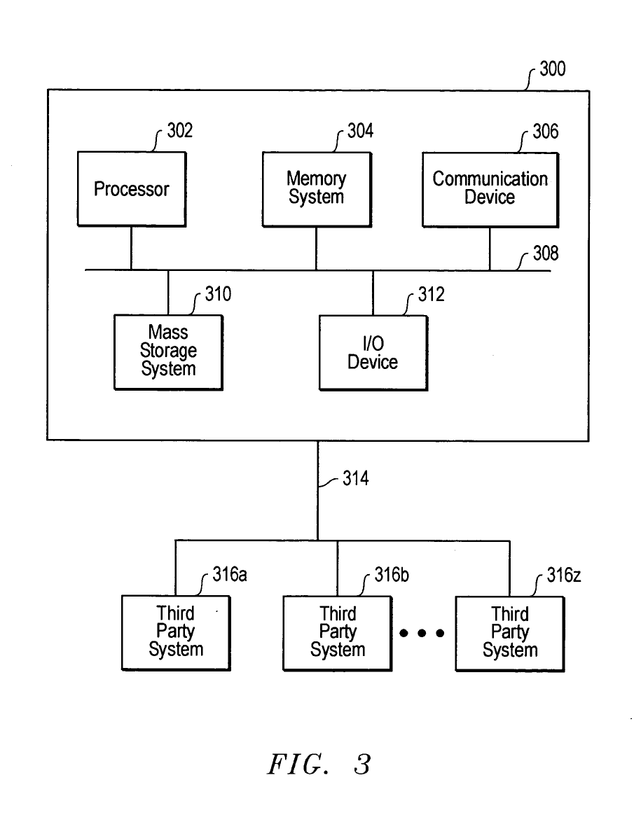

Referring now to FIG. 3, a computer system according to one embodiment of the present invention is shown. A computer system 300 is shown including a processor 302, a memory system 304, a communication device 306, a mass storage device 310, and an I/O device 312, all connected via bus 308. The communication device 306 includes an Internet communication device which allows the computer system 300 to be connected to the Internet via any Internet connection 314, including standard phone lines, direct connection or wireless connection.

The processor 302 includes processors commonly known to those skilled in the art and which are commonly available. The memory system 304 includes random access memory (RAM) and read-only memory (ROM). The bus 308 includes buses commonly know to those skilled in the art and which are commonly available. The mass storage system 310 includes a hard disk drive, a read/write CD drive, an optical drive, tape drive, or a removable drive. The mass storage system 310 must be of sufficient size to store a database of records related to the obtained asset rights, such database including, but not limited to, identity of asset holder, asset, asset industry, licensee fee, royalty fee, asset expiration. The I/O device 312 includes a keyboard and mouse among others. The I/O device 312 allows for the input and output of data to the computer system 300. IPIT software is resident in the memory system 304 or the mass storage system 310 and is executable by the processor 302.

The computer system 300 is connected to third party computer systems 316a-z via the internet connection 314. The third party computer systems 316a-z include, but are not limited to patent holders, IPOP licensees, patent fee service companies, and patent databases such as the patent database at the United States Patent and Trademark Office and the Delphion patent database.

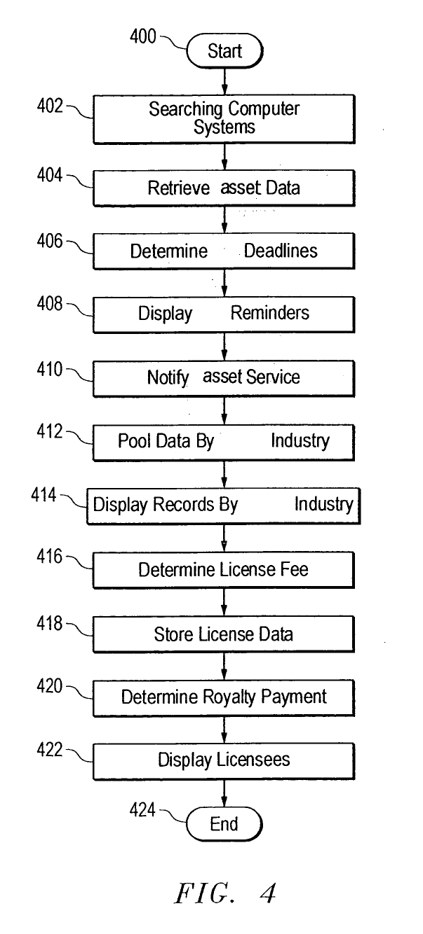

Referring now to FIG. 4, a flow chart depicting the IPOP method is shown. The method begins with Start 400. In step 402, third party computer systems are searched. Based upon the asset rights obtained from the asset holder, inventor specific or asset specific data is searched for on the third party computer systems. In one disclosed embodiment, this search is conducted on a predetermined period, such as once a week. Third party computer systems such as the United States Patent & Trademark Office and Delphion are searched. A search of all assets is conducted with any additional or new information be identified. Next, in step 404, the data identified during the search is downloaded. For patents, the full text, including description and claims, and drawings of the particular patent is downloaded and viewable. For trademarks, the dates of registration, description of goods and services and the international classification are downloaded and viewable. Maintenance fee and patent family history is also downloaded and associated with the records related to the particular patent or patent holder.

Next, in step 406, future maintenance deadlines for the particular asset are calculated and stored with the records related to the particular asset. In step 408, the future maintenance deadlines are displayed to individuals reviewing the records for a particular asset. Next in step 410, a predetermined maintenance fee service is notified regarding the particular asset. The particular assets include, but are not limited to, patents, trademarks and copyrights. Upon agreement from the asset holder, the maintenance fee service is automatically notified prior to the expiration of the particular asset regarding instructions for payment of the necessary fees and filing of any necessary documents. The cost of the fees is then noted in the records and deducted from any royalty payments due to the asset holder.

Next, in step 412, the records of a particular industry are pooled. The records of all the assets in the particular industry are grouped and combined and associated with the particular industry. In step 414, the pooled group is displayed. A third party accesses the IPOP computer system and selects a particular industry. Once selected, the records relating to the assets in that particular industry are viewable. The third party may access the IPOP computer system through a direct connection or through an Internet connection. Further, the records relating to the assets in a particular industry may be downloadable. This feature may be limited to a subset of all third parties, specifically, the downloadable feature may only be available to licensed IPOP users.

In one embodiment, IPOP licensees have access to information of the asset holders, including the availability of expert consulting. Contact information for the asset holders is also available or a blind email may be provided. Additional technology or equipment related to the particular asset of the asset holder may be listed in the records along with conditions for rental or purchase. Automated rental request of technology, equipment or prototypes may also be included. Fees collected may be combined and accounted for automatically.

Next, in step 416, the license fee for the asset pool is determined. The quantity and quality of the asset rights contained within a particular industry are evaluated with a standard license fees calculated based upon predetermined factors. In one disclosed embodiment, the asset holder selects from a predetermined terms and conditions the specific rights to be transferred to the asset pool. Specifically, the asset holder selects the length of the license grant, the exclusivity of the license grant, and selects the fee to be paid by the IPOP participant. Once the particular asset right is licensed, the licensed data is stored with the records related to the particular asset in the particular industry in step 418. The IPOP system allows the IPOP participant to purchase an option to an asset, a non-exclusive license, an exclusive license, all rights in the asset automatically. The specific right along with stated price are viewable for the IPOP participant. Next, in step 420, the royalty payments to the asset holders for the assets related to the particular industry are determined. The royalty amounts are controlled by the first set of predetermined terms and conditions and are triggered upon the entry of an IPOP license for the asset right. In step 422, the licensees of a particular asset right are displayed to other licensees and third parties. Once a licensee ceases payment, the licensee is removed from the IPOP list and all remaining IPOP licensees are notified. The method ends with 424.

In one disclosed embodiment, assets would be removed from the database as they expire. The removal could be automated and notice to the IPOP licensees and asset holders can be automatically sent. Further, new assets of an asset holder may be included if the asset right obtained requires such action. In one disclosed embodiment, financial, accounting and auditing capabilities are available for IPOP licensees and asset holders.

In one disclosed embodiment, the IPOP and IPIT are methods of reducing transaction costs by allowing a third party or the asset owner to transfer the asset rights to an entity, rather than the IPOP and IPIT obtaining the rights.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

1-50. (canceled)

51. A computer-implemented method, comprising:
forming a pool of rights in a plurality of intangible assets obtained from a plurality of patent owners;
storing information regarding the plurality of intangible assets in a storage device, wherein the plurality of intangible assets is owned by at least one original owner;
storing information regarding a price to obtain an option to obtain a license for at least one intangible asset of the plurality of intangible assets from the at least one original owner wherein the price to obtain the option corresponds to the cost of the option, and storing information regarding a price to obtain a license for the at least one intangible asset from the at least one original owner;
receiving a request for information for obtaining an option to obtain a license for the at least one intangible asset of the plurality of intangible assets with a receiver, wherein the request for information for obtaining an option to obtain a license for the at least one intangible asset of the plurality of intangible assets is transmitted from a communication device of or associated with a requesting party;
processing the request for information for obtaining an option to obtain a license for the at least one intangible asset of the plurality of intangible assets with a processor;
determining a price for obtaining the option to obtain a license for the at least one intangible asset of the plurality of intangible assets based upon at least one term or condition for the option to obtain a license for the at least one intangible asset of the plurality of intangible assets, wherein said at least one term or condition for the option comprises said defined time duration, and wherein said price is a fixed price determined independently of an identity of the requesting party to be common for all the patent owners; and
generating a message in response to the request for information for obtaining an option to obtain a license for the at least one intangible asset of the plurality of intangible assets, wherein the message contains at least one term or condition for the option to obtain a license for the at least one intangible asset of the plurality of intangible assets, and further wherein the message contains a price for obtaining the option to obtain a license for the at least one intangible asset of the plurality of intangible assets;
transmitting the message to the communication device;
storing information regarding the obtained price for issuing the option, wherein the information regarding the obtained price is transmitted from the communication device; and
issuing the option to the requesting party.

52. The computer-implemented method of claim 51, further comprising:
receiving a request for information for obtaining a license for the at least one intangible asset of the plurality of intangible assets with a receiver, wherein the request for obtaining a license for the at least one intangible asset of the plurality of intangible assets is transmitted from the communication device;
processing the request for information for obtaining a license for the at least one intangible asset of the plurality of intangible assets;
generating a second message in response to the request for information for obtaining a license for the at least one intangible asset of the plurality of intangible assets, wherein the second message contains information regarding an issuance of a license for the at least one intangible asset of the plurality of intangible assets; and
transmitting the message to the communication device.

53. The computer-implemented method of claim 52, further comprising:
issuing a license for the at least one intangible asset of the plurality of intangible assets.

54. The computer-implemented method of claim 51, wherein a perceived cost of negotiating the option to obtain a license for the at least one intangible asset of the plurality of intellectual assets exceeds a perceived benefit of obtaining the license for the at least one intangible asset of the plurality of intellectual assets.

55. The computer-implemented method of claim 51, wherein the plurality of intangible assets pertain to a product, products, service, or services within a field, industry, or classification.

56. The computer-implemented method of claim 55, wherein the field, industry, or classification is defined by a Standard Industrial Classification (SIC) number or by a North American Industry Classifications System (NAICS) number.

57. The computer-implemented method of claim 51, wherein the message contains information for obtaining a license to the at least one intangible asset of the plurality of intangible assets.

58. The computer-implemented method of claim 51, wherein the option to obtain a license for the at least one intangible asset of the plurality of intangible assets is an option to obtain a non-exclusive license for the at least one intangible asset of the plurality of intangible assets.

59. The computer-implemented method of claim 51, wherein the option to obtain a license for the at least one intangible asset of the plurality of intangible assets is an option to obtain an exclusive license for the at least one intangible asset of the plurality of intangible assets, and wherein the exclusive license includes a right to exclude others for the duration of the exclusive license.

60. The computer-implemented method of claim 51, wherein the price to obtain the option to obtain a license is a one-time fixed price, a one-time calculated price, a recurring fixed price, or a recurring calculated price.

61. The computer-implemented method of claim 53, further comprising:
storing information regarding a financial return realized from the license to the at least one intangible asset of the plurality of intangible assets;
calculating a royalty based on a percentage of the financial return;
generate a third message containing information regarding the royalty;
transmitting the third message to a second communication device, wherein the second communication device is associated with an asset holder of the at least one intangible asset of the plurality of intangible assets.

62. The computer-implemented method of claim 53, wherein the price to obtain the license for the at least one intangible asset of the plurality of intangible assets is based upon a use of the license.

63. The computer-implemented method of claim 53, wherein the plurality of intangible assets includes at least a trademark, a patent, or a copyright.

64. A computer-implemented method for creating value from underutilized intellectual property comprising:
storing information regarding a plurality of intangible assets in a storage device, wherein the plurality of intangible assets is owned by at least one original owner;
storing information regarding a pool of intangible assets, wherein the pool of intangible assets includes at least two intangible assets of the plurality of intangible assets;
storing information regarding a price to obtain an option to obtain a license for at least one intangible asset in the pool of intangible assets from the at least one original owner wherein the price to obtain the option corresponds to the cost of the option, and storing information regarding a price to obtain a license for at least one intangible asset in the pool of intangible assets from the at least one original owner;
receiving a request for information for obtaining an option to obtain a license for the at least one intangible asset in the pool of intangible assets with a receiver, wherein the request for information for obtaining an option to obtain a license for the at least one intangible asset in the pool of intangible assets is transmitted from a communication device of or associated with a requesting party;
processing the request for information for obtaining an option to obtain a license for the at least one intangible asset in the pool of intangible assets with a processor;
determining a price for obtaining the option to obtain a license for the at least one intangible asset of the plurality of intangible assets based upon at least one term or condition for the option to obtain a license for the at least one intangible asset of the plurality of intangible assets, wherein said at least one term or condition for the option comprises said defined time duration, and wherein said price is a fixed price determined independently of an identity of the requesting party; and
generating a message in response to the request for information for obtaining an option to obtain a license for the at least one intangible asset in the pool of intangible assets, wherein the message contains at least one term or condition of the option to obtain a license for the at least one intangible asset in the pool of intangible assets, and further wherein the message contains a price for obtaining the option to obtain a license for the at least one intangible asset in the pool of intangible assets; and
transmitting the message to the communication device;
storing information regarding the price received for issuing the option, wherein the information regarding the received price is transmitted from the communication device; and
issuing the option to the requesting party.

65. The computer-implemented method of claim 64, further comprising:
receiving a request for information for obtaining a license for the at least one intangible asset in the pool of intangible assets, wherein the request for obtaining a license for the at least one intangible asset in the pool of intangible assets is transmitted from the communication device;
processing the request for information for obtaining a license for the at least one intangible asset in the pool of intangible assets; and
generating a second message in response to the request for information for obtaining a license for the at least one intangible asset in the pool of intangible assets, wherein the second message contains information regarding an issuance of a license for the at least one intangible asset in the pool of intangible assets; and
transmitting the second message to the communication device.

66. The computer-implemented method of claim 65, further comprising:
issuing a license for the at least one intangible asset in the pool of intangible assets.

67. The computer-implemented method of claim 65, further comprising:
determining whether the requesting party is authorized to receive the information for obtaining the license for the at least one intangible asset in the pool of intangible assets.

68. The computer-implemented method of claim 64, wherein a perceived cost of negotiating the option to obtain a license for the at least one intangible asset in the pool of intangible assets exceeds a perceived benefit of obtaining the license for the at least one intangible asset in the pool of assets.

69. The computer-implemented method of claim 64, wherein the plurality of intangible assets pertain to a product, products, service, or services within a field, industry, or classification.

70. The computer-implemented method of claim 69, wherein the field, industry, or classification is defined by a Standard Industrial Classification (SIC) number or by a North American Industry Classifications System (NAICS) number.

71. The computer-implemented method of claim 64, wherein the message contains information for obtaining a license for the at least one intangible asset in the pool of intangible assets.

72. The computer-implemented method of claim 64, wherein the option to obtain a license for the at least one intangible asset in the pool of intangible assets is an option to obtain a non-exclusive license for the at least one intangible asset in the pool of intangible assets.

73. The computer-implemented method of claim 64, wherein the option to obtain a license for the at least one intangible asset in the pool of intangible assets is an option to obtain an exclusive license for the at least one intangible asset in the pool of intangible assets, and wherein the exclusive license includes a right to exclude others for the duration of the exclusive license.

74. The computer-implemented method of claim 64, wherein the price to obtain the option to obtain a license is a one-time fixed price, a one-time calculated price, a recurring fixed price, or a recurring calculated price.

75. The computer-implemented method of claim 65, further comprising:
storing information regarding a financial return realized from the license to the at least one intangible asset in the pool of intangible assets;
calculating a royalty based on a percentage of the financial return;
generating a third message containing information regarding the royalty; and
transmitting the third message to a second communication device, wherein the second communication device is associated with an asset holder of the at least one intangible asset in the pool of intangible assets.

76. The computer-implemented method of claim 64, wherein the price to obtain a license for the at least one intangible asset in the pool of intangible assets is based upon a use of the license.

77. The computer-implemented method of claim 64, wherein the plurality of intangible assets includes at least a trademark, a patent, or a copyright.

78. An apparatus for creating value from underutilized intellectual property comprising:
a storage device, wherein the storage device stores information regarding a pool of intangible assets, wherein the pool of intangible assets includes at least two intangible assets of a plurality of intangible assets, information regarding a price to obtain an option to obtain a license for at least one intangible asset of the plurality of intangible assets wherein the price to obtain the option corresponds to the cost of the option, information regarding a price to obtain a license for the at least one intangible asset, and information regarding the price obtained for issuing the option, wherein each of the intangible assets is owned by at least one original owner;
a receiver, wherein the receiver receives a request for information for obtaining an option to obtain a license for the at least one intangible asset of the plurality of intangible assets from the at least one original owner, wherein the request for information for obtaining an option to obtain a license for the at least one intangible asset of the plurality of intangible assets is transmitted from a communication device of or associated with a requesting party;
a processor, wherein the processor processes the request for information for obtaining the option to obtain a license for the at least one intangible asset of the plurality of intangible assets, and processes information for issuing the option, and for determining a price for obtaining the option to obtain a license for the at least one intangible asset of the plurality of intangible assets based upon at least one term or condition for the option to obtain a license for the at least one intangible asset of the plurality of intangible assets, wherein said at least one term or condition for the option comprises said defined time duration, and wherein said price is a fixed price determined independently of an identity of the requesting party; and
wherein the processor generates a message in response to the request for information for obtaining an option to obtain a license for the at least one intangible asset of the plurality of intangible assets,
wherein the message contains at least one term or condition of the option to obtain a license for the at least one intangible asset of the plurality of intangible assets, and
further wherein the message contains a price for obtaining the option to obtain a license for the at least one intangible asset of the plurality of intangible assets; and
a transmitter, wherein the transmitter transmits the message to the communication device.

79. The apparatus of claim 78, wherein the apparatus receives a request for information for obtaining a license for the at least one intangible asset of the plurality of intangible assets with a receiver,
wherein the request for obtaining a license for the at least one intangible asset of the plurality of intangible assets is transmitted from the communication device, and
further wherein the apparatus processes the request for information for obtaining a license for the at least one intangible asset of the plurality of intangible assets, and
further wherein the apparatus generates a second message in response to the request for information for obtaining a license for the at least one intangible asset of the plurality of intangible assets,
wherein the second message contains information regarding an issuance of a license for the at least one intangible asset of the plurality of intangible assets, and
further wherein the apparatus transmits the message to the communication device.

80. The apparatus of claim 79, wherein the apparatus issues a license for the at least one intangible asset of the plurality of intangible assets.

81. The apparatus of claim 78, wherein a perceived cost of negotiating the option to obtain a license for the at least one intangible asset of the plurality of intellectual assets exceeds a perceived benefit of obtaining the license for the at least one intangible asset of the plurality of intellectual assets.

82. The apparatus of claim 78, wherein the plurality of intangible assets pertain to a product, products, service, or services within a field, industry, or classification.

83. The apparatus of claim 82, wherein the field, industry, or classification, is defined by a Standard Industrial Classification (SIC) number or by a North American Industry Classifications System (NAICS) number.

84. The apparatus of claim 78, wherein the message contains information for obtaining a license to the at least one intangible asset of the plurality of intangible assets.

85. The apparatus of claim 78, wherein the option to obtain a license for the at least one intangible asset of the plurality of intangible assets is an option to obtain a non-exclusive license for the at least one intangible asset of the plurality of intangible assets.

86. The apparatus of claim 78, wherein the option to obtain a license for the at least one intangible asset of the plurality of intangible assets is an option to obtain an exclusive license for the at least one intangible asset of the plurality of intangible assets, and wherein the exclusive license includes a right to exclude others for the duration of the exclusive license.

87. The apparatus of claim 78, wherein the price to obtain the option is a one-time fixed price, a one-time calculated price, a recurring fixed price, or a recurring calculated price.

88. The apparatus of claim 78, wherein the apparatus stores information regarding a financial return realized from the license to the at least one intangible asset of the plurality of intangible assets, and further wherein the apparatus calculates a royalty based on a percentage of the financial return, and further wherein the apparatus generates a third message containing information regarding the royalty, and further wherein the apparatus transmits the third message to a second communication device, wherein the second communication device is associated with an asset holder of the at least one intangible asset of the plurality of intangible assets.

89. The apparatus of claim 78, wherein the price to obtain the license for the at least one intangible asset of the plurality of intangible assets is based upon a use of the license.

90. The apparatus of claim 78, wherein the plurality of intangible assets includes at least a trademark, a patent, or a copyright.

91. An apparatus for creating revenue from underutilized intellectual property comprising:
a storage device, wherein the storage device stores information regarding a plurality of intangible assets, information regarding a pool of intangible assets, and stores information regarding the price received for issuing the option, wherein the pool of intangible assets includes at least two intangible assets of the plurality of intangible assets, information regarding a price to obtain an option to obtain a license for the pool of intangible assets wherein the price to obtain the option corresponds to the cost of the option, and information regarding a price to obtain a license for the pool of intangible assets, wherein each of the intangible assets is owned by at least one original owner;
a receiver, wherein the receiver receives a request for information for obtaining an option to obtain a license for the pool of intangible assets from the at least one original owner, wherein the request for information for obtaining an option to obtain a license for the pool of intangible assets is transmitted from a communication device of or associated with a requesting party;
a processor, wherein the processor processes the request for information for obtaining an option to obtain a license for the pool of intangible assets, and processes information for issuing the option, and wherein the processor generates a message in response to the request for information for obtaining an option to obtain a license for the pool of intangible assets, wherein the message contains at least one term or condition of the option to obtain a license for the pool of intangible assets, and further wherein the message contains a price for obtaining the option to obtain a license for the pool of intangible assets; and for determining a price for obtaining the option to obtain a license for the at least one intangible asset of the plurality of intangible assets based upon at least one term or condition for the option to obtain a license for the at least one intangible asset of the plurality of intangible assets, wherein said at least one term or condition for the option comprises said defined time duration, and wherein said price is a fixed price determined independently of an identity of the requesting party; and
a transmitter, wherein the transmitter transmits the message to the communication device.

92. The apparatus of claim 91, wherein the apparatus receives a request for information for obtaining a license for the at least one intangible asset in the pool of intangible assets,
wherein the request for obtaining a license for the at least one intangible asset in the pool of intangible assets is transmitted from the communication device, and
further wherein the apparatus processes the request for information for obtaining a license for the at least one intangible asset in the pool of intangible assets, and
further wherein the apparatus generates a second message in response to the request for information for obtaining a license for the at least one intangible asset in the pool of intangible assets,
wherein the second message contains information regarding an issuance of a license for the at least one intangible asset in the pool of intangible assets, and
further wherein the apparatus transmits the second message to the communication device.

93. The apparatus of claim 92, wherein the apparatus issues a license for the at least one intangible asset in the pool of intangible assets.

94. The apparatus of claim 92, wherein the apparatus determines whether the requesting party is authorized to receive the information for obtaining the license for the at least one intangible asset in the pool of intangible assets.

95. The apparatus of claim 91, wherein a perceived cost of negotiating the option to obtain a license for the at least one intangible asset in the pool of intangible assets exceeds a perceived benefit of obtaining the license for the at least one intangible asset in the pool of assets.

96. The apparatus of claim 91, wherein the plurality of intangible assets pertain to a product, products, service, or services within a field, industry, or classification.

97. The apparatus of claim 96, wherein the field, industry, or classification is defined by a Standard Industrial Classification (SIC) number or by a North American Industry Classifications System (NAICS) number.

98. The apparatus of claim 91, wherein the message contains information for obtaining a license for the at least one intangible asset in the pool of intangible assets.

99. The apparatus of claim 91, wherein the option to obtain a license for the at least one intangible asset in the pool of intangible assets is an option to obtain a non-exclusive license for the at least one intangible asset in the pool of intangible assets.

100. The apparatus of claim 91, wherein the option to obtain a license for the at least one intangible asset in the pool of intangible assets is an option to obtain an exclusive license for the at least one intangible asset in the pool of intangible assets.

101. The apparatus of claim 91, wherein the price to obtain the option is a one-time fixed price, a one-time calculated price, a recurring fixed price, or a recurring calculated price.

102. The apparatus of claim 92, wherein the apparatus stores information regarding a financial return realized from the license to the at least one intangible asset in the pool of intangible assets, and
further wherein the apparatus calculates a royalty based on a percentage of the financial return, and
further wherein the apparatus generates a third message containing information regarding the royalty, and
further wherein the apparatus transmits the third message to a second communication device,
wherein the second communication device is associated with an asset holder of the at least one intangible asset in the pool of intangible assets.

103. The apparatus of claim 91, wherein the price to obtain a license for the at least one intangible asset in the pool of intangible assets is based upon a use of the license.

104. The apparatus of claim 91, wherein the plurality of intangible assets includes at least a trademark, a patent, or a copyright.

105. A computer-implemented method for creating revenue from underutilized intellectual property comprising:
storing information regarding a plurality of intangible assets in a storage device, wherein the plurality of intangible assets is owned by at least one original owner;
storing information regarding a pool of intangible assets, wherein the pool of intangible assets includes at least two intangible assets of the plurality of intangible assets;
storing information regarding a price to obtain an option to purchase at least one intangible asset in the pool of intangible assets from the at least one original owner wherein the price to obtain the option corresponds to the cost of the option, and storing information regarding a price to purchase the at least one intangible asset in the pool of intangible assets from the at least one original owner;
receiving a request for information for obtaining an option to purchase the at least one intangible asset in the pool of intangible assets with a receiver, wherein the request for information for obtaining an option to purchase the at least one intangible asset in the pool of intangible assets is transmitted from a communication device of or associated with a requesting party;
processing the request for information for obtaining an option to purchase the at least one intangible asset in the pool of intangible assets with a processor;
determining a price for obtaining the option to obtain a license for the at least one intangible asset of the plurality of intangible assets based upon at least one term or condition for the option to obtain a license for the at least one intangible asset of the plurality of intangible assets wherein said at least one term or condition for the option comprises said defined time duration and wherein said price is a fixed price determined independently of an identity of the requesting party;
generating a message in response to the request for information for obtaining an option to purchase the at least one intangible asset in the pool of intangible assets, wherein the message contains at least one term or condition of the option to purchase the at least one intangible asset in the pool of intangible assets, and further wherein the message contains a price for obtaining an option to purchase the at least one intangible asset in the pool of intangible assets; and
transmitting the message to the communication device; storing information regarding the price received for issuing the option, wherein the information regarding the received price is transmitted from the communication device; and
issuing the option to the requesting party.

106. The computer-implemented method of claim 105, further comprising:
receiving a request for information for purchasing the at least one intangible asset in the pool of intangible assets, wherein the request for purchasing the at least one intangible asset in the pool of intangible assets is transmitted from the communication device;
processing the request for information for purchasing the at least one intangible asset in the pool of intangible assets; and
generating a second message in response to the request for information for purchasing the at least one intangible asset in the pool of intangible assets, wherein the second message contains information regarding selling the at least one intangible asset in the pool of intangible assets; and
transmitting the second message to the communication device.

107. The computer-implemented method of claim 106, further comprising:
selling the at least one intangible asset in the pool of intangible assets.

108. The computer-implemented method of claim 106, further comprising:
determining whether the requesting party is authorized to receive the information for purchasing the at least one intangible asset in the pool of intangible assets.

109. The computer-implemented method of claim 105, wherein a perceived cost of negotiating the option to purchase the at least one intangible asset in the pool of intangible assets exceeds a perceived benefit of purchasing the at least one intangible asset in the pool of assets.

110. The computer-implemented method of claim 105, wherein the plurality of intangible assets pertain to a product, products, service, or services within a field, industry, or classification.

111. The computer-implemented method of claim 110, wherein the field, industry, or classification is defined by a Standard Industrial Classification (SIC) number or by a North American Industry Classifications System (NAICS) number.

112. The computer-implemented method of claim 105, wherein the message contains information for purchasing the at least one intangible asset in the pool of intangible assets.

113. The computer-implemented method of claim 105, wherein the price to obtain the option is a one-time fixed price, a one-time calculated price, a recurring fixed price, or a recurring calculated price.

114. The computer-implemented method of claim 105, further comprising:
storing information regarding the purchase price for the at least one intangible asset in the pool of intangible assets, wherein the purchase price is the calculated price.

115. The computer-implemented method of claim 105, wherein the plurality of intangible assets includes at least a trademark, a patent, or a copyright.

116. An apparatus for creating revenue from underutilized intellectual property comprising:
a storage device, wherein the storage device stores information regarding a plurality of intangible assets, information regarding a pool of intangible assets, wherein the pool of intangible assets includes at least two intangible assets of the plurality of intangible assets, information regarding a price to obtain an option to purchase the at least one intangible asset in the pool of intangible assets wherein the price to obtain the option corresponds to the cost of the option, and information regarding a price to purchase the at least one intangible asset in the pool of intangible assets, and stores information regarding a price received for issuing the option and a price received for purchasing the at least one intangible asset, wherein the plurality of intangible assets is owned by at least one original owner;
a receiver, wherein the receiver receives a request for information for obtaining an option to purchase the at least one intangible asset in the pool of intangible assets from the at least one original owner, wherein the request for information for obtaining an option to purchase the at least one intangible asset in the pool of intangible assets is transmitted from a communication device of or associated with a requesting party;
a processor, wherein the processor processes the request for information for obtaining an option to purchase the at least one intangible asset in the pool of intangible assets, and wherein the processor generates a message in response to the request for information for obtaining an option to purchase the at least one intangible asset in the pool of intangible assets, wherein the message contains at least one term or condition of the option to purchase the at least one intangible asset to the pool of intangible assets, and further wherein the message contains a price for obtaining the option to purchase the at least one intangible asset to the pool of intangible assets; and for determining a price for obtaining the option to obtain a license for the at least one intangible asset of the plurality of intangible assets based upon at least one term or condition for the option to obtain a license for the at least one intangible asset of the plurality of intangible assets, wherein said at least one term or condition for the option comprises said defined time duration, and wherein said price is a fixed price determined independently of an identity of the requesting party; and
a transmitter, wherein the transmitter transmits the message to the communication device.

117. The apparatus of claim 116, wherein the apparatus receives a request for information for purchasing the at least one intangible asset to the at least one intangible asset in the pool of intangible assets, wherein the request for purchasing the at least one intangible asset in the pool of intangible assets is transmitted from the communication device, and further wherein the apparatus processes the request for information for purchasing the at least one intangible asset in the pool of intangible assets, and further wherein the apparatus generates a second message in response to the request for information for purchasing the at least one intangible asset in the pool of intangible assets, wherein the second message contains information regarding purchasing the at least one intangible asset in the pool of intangible assets, and further wherein the apparatus transmits the second message to the communication device.

118. The apparatus of claim 117, wherein the apparatus sells the at least one intangible asset in the pool of intangible assets.

119. The apparatus of claim 117, wherein the apparatus determines whether the requesting party is authorized to receive the information for purchasing the at least one intangible asset in the pool of intangible assets.

120. The apparatus of claim 116, wherein a perceived cost of negotiating the option to purchase the at least one intangible asset in the pool of intangible assets exceeds a perceived benefit of purchasing the at least one intangible asset in the pool of assets.

121. The apparatus of claim 116, wherein the plurality of intangible assets pertain to a product, products, service, or services within a field, industry, or classification.

122. The apparatus of claim 121, wherein the field, industry, or classification is defined by a Standard Industrial Classification (SIC) number or by a North American Industry Classifications System (NAICS) number.

123. The apparatus of claim 116, wherein the message contains information for purchasing the at least one intangible asset in the pool of intangible assets.

124. The apparatus of claim 116, wherein the price to obtain the option is a one-time fixed price, a one-time calculated price, a recurring fixed price, or a recurring calculated price.

125. The apparatus of claim 117, wherein the apparatus stores information regarding the purchase price for the at least one intangible asset in the pool of intangible assets, and further wherein the purchase price is the calculated price.

126. The apparatus of claim 116, wherein the plurality of intangible assets includes at least a trademark, a patent, or a copyright.
